(19) United States
(12) Patent Application Publication
(10) Pub. No.: US 2017/0153067 A1
(43) Pub. Date: Jun. 1, 2017

(54) COMPOSITE FIBER CAPILLARY STRUCTURE, HEAT PIPE THEREOF AND FABRICATING METHOD FOR THE SAME

(71) Applicant: Industrial Technology Research Institute, HSIN-CHU (TW)

(72) Inventors: WEI-CHUN LO, Taoyuan City (TW); KAI-SHING YANG, Changhua County (TW)

(21) Appl. No.: 14/980,164

(22) Filed: Dec. 28, 2015

(30) Foreign Application Priority Data
Nov. 27, 2015 (TW) 104139719

(51) Int. Cl. F28D 15/04; B23P 15/26; B21F 45/06

(52) U.S. Cl. CPC F28D 15/046; B21F 45/06; B23P 15/26

(57) ABSTRACT

A composite fiber capillary structure includes a first interlacing layer and a second interlacing layer. The first interlacing layer is formed as a hollow cylindrical net structure by metal wires with a first diameter. The second interlacing layer is also formed as a hollow cylindrical net structure by metal wires with a second diameter. The first diameter is larger than the second diameter, and the second interlacing layer covers the first interlacing layer in a sleeving manner. In addition, a fabricating method of the composite fiber capillary structure and a heat pipe with the composite fiber capillary structure are also provided.

### CROSS REFERENCE TO RELATED APPLICATION

The present application is based on, and claims priority from, Taiwan (International) Application Serial Number 104139719, filed on Nov. 27, 2015 the disclosure of which is hereby incorporated by reference herein in its entirety.

### TECHNICAL FIELD

The present disclosure relates to a composite fiber capillary structure, a heat pipe thereof and a fabricating method for the same, and more particularly to the composite fiber capillary structure, the fabricating method for the composite fiber capillary structure, and the heat pipe having the composite fiber capillary structure, in which the composite fiber capillary structure is formed by interlacing metal wires into a braided double-layer structure having an inner layer and an outer layer, preferably in which a diameter of the metal wire for the inner layer is larger than that for the outer layer.

### BACKGROUND

In order to reduce the cost without sacrificing application flexibility and competitiveness, electronic products such as computers, smart phones, projectors and high-performance LED illuminators all fall into a light-and-thin design trend. However, the volume-reduced products may suffer from a more serious problem in heat dissipation. It is well known that the high temperature in these products would inevitably cause downgrading in performance and stability. The problem heat-dissipation in a light-and-thin electronic product is usually localized to a specific region or component, such as an operational processing unit and a light source for LEDs. To overcome the localized heat point, a thin heat-dissipating product with high thermal conductivity is definitely welcome to the art.

On the other hand, in a conventional heat-pipe product, the heat pipe is featured in a vapor chamber containing a gas-phase work fluid and a capillary structure for circulating the fluid. When the work fluid absorbs enough heat to become a gas-phase steam at a vapor end of the heat pipe, the steam carries the heat to an opposing condensing end through the vapor chamber. At the condensing end, the heat in the steam is dissipated and thus the steam is transformed into a liquid-phase fluid. The liquid-phase fluid is then conveyed back to the vapor end by the capillary structure. Such a heat-dissipation pattern is repeated continuously to maintain the premier heat-dissipation performance. However, in designing the heat-pipe products, following difficulties shall be encountered.

A. Since the major difference between the thin heat pipe and the conventional heat pipe is that the thin heat pipe has a reduced cross section caused by a depress-to-flat process. However, with the same capillary structure, the depress-to-flat process would cause the space for the steam at the capillary structure to be reduced, even though the cross section area might not vary. Thus, compared to the conventional heat pipe, the pressure loss of the steam in the thin heat pipe becomes a problem. For example, as the thin heat pipe is depressed from a 2-mm thickness to a 0.8-mm thickness, the multiplier of the effective length and the maximum heat-dissipation quantity would be evenly reduced to be 1/7 of the heat pipe prior to the depress-to-flat process.

B. Though the fabricating method for producing the conventional heat pipe, such as the sintering process, the trenching process, the metal netting process or the composite heat-pipe process, may still prevail in fabricating the thin heat tube, yet the thin heat pipe with a thickness less than 1 mm is hard to be applicable. In particular, for such a thin heat pipe, only 0.7 mm-height interior space is left in the capillary structure after subtracting the 0.2-0.3 mm wall thickness from the 1 mm thickness. However, it is necessary to leave enough space for conveying the steam in the capillary structure no matter what the thickness of the heat pipe is. Hence, the design in the capillary structure for the thin heat pipe becomes harsh and critical, and shall be extremely cautious so as to maintain an acceptable balance among the pressure difference, the gas-phase pressure loss and the liquid-phase pressure loss.

C. Since non-uniform depression might occur during the depress-to-flat process upon the heat pipe, so a central concave area would appear to the depressed heat pipe. If the central concave area is produced, wider contact spacing would exist between the heat pipe and the heat source or the condensing end. Such spacing would lead to an increase in the contact thermal resistance. In addition, since possible distortion or deformation may also occur, the cross sectional area of the steam duct of the capillary structure would be smaller than expected, and thereby the whole performance of the heat pipe might be degraded further. Currently, a common resort is to arrange the capillary structure to a middle portion of the heat pipe so as further to provide an additional reinforcement. Furthermore, a heating method can be also applied to increase the internal pressure of the heat pipe, such that an outward push would be induced during the depress-to-flat process for preventing the depressed heat pipe from unnecessary deformation. Anyway, it is sure that the heat pipe after the depress-to-flat process shall have a structural strength enough to survive the pressure variation while the heat pipe in application. Thereupon, the weak point of the heat pipe would be still all right under the atmosphere pressure or under an excess internal pressure.

Currently, plenty of heat-pipe manufacturers have been devoted to the manufacturing of the capillary structure for the thin heat pipe with a thickness less than 1 mm. These manufacturing can include the sintering process, the trenching process, the metal netting process, the fiber-bundle or composite heat-pipe process. The sintering process is mainly to adopt and further improve the conventional tubular sintering process, and to produce specific molds for sintering the copper powders to a specific area inside the copper tube. To the depress-to-flat process for forming the thin heat pipe, the process difficulty and cost of the sintering process are high though a capillary structure with better performance can be obtained. Thus, the application of the depress-to-flat process can't go further in producing the future thin products. Regarding the capillary structure produced by the trenching and the metal netting processes, though the lower cost is obvious, yet the resulted larger capillary radius would lead to insufficient capillary forces. Therefore, some manufacturers propose a composite capillary structure design for elevating the performance. However, the tradeoff would be the manufacturing difficulty and the cost. On the other hand, the fiber-bundle design is much relevant to the capillary structure of the ultra-thin heat pipe for its smaller wire sizes can sustain a supportive structure for rendering larger capillary forces and smaller heights. In addition, the conventional coaxial braided capillary structure that is produced by interlacing a plurality of metal wires can provide the inter-wire space for capillary transmission. However, since the core portion thereof is formed as a hollow longitudinal pipe, thus only a flat, wide and loosen capillary structure can be obtained after the depress-to-flat process. The effective compact and focused capillary structure is hard to achieve by this fiber-bundle manufacturing design. Also, complicated structures inside the flow duct would lead to unexpected flow resistance, and thereby the overall performance is substantially downgraded.

Accordingly, the capillary structure of the thin heat pipe provides a poor capillary transmission capacity than the normal heat pipe does. Hence, a specific design for balancing the steam flows inside the capillary structure and the chamber so as to enhance the capillary transmission capacity is definitely welcome to the art.

### SUMMARY

In one embodiment of this disclosure, a composite fiber capillary structure, comprises:

a first interlacing layer, formed as a hollow cylindrical net structure by metal wires with a first diameter; and

a second interlacing layer, formed as another hollow cylindrical net structure by another metal wires with a second diameter, the first diameter being larger than the second diameter, the second interlacing layer covering the first interlacing layer in a sleeving manner.

In one embodiment of this disclosure, a fabricating method of a composite fiber capillary structure, comprises the steps of:

preparing a core wire;

wrapping the core wire by a first interlacing layer, the first interlacing layer being formed as a net structure of metal wires with a first diameter;

wrapping the first interlacing layer by a second interlacing layer, the second interlacing layer being formed as another net structure of metal wires with a second diameter, the first diameter being larger than the second diameter; and

pulling away the core wire.

In one embodiment of this disclosure, a heat pipe, comprises:

an outer chamber structure, vacuum sealed, containing thereinside a work fluid; and

a composite fiber capillary structure, located inside the outer chamber structure, further comprising:

a first interlacing layer, formed as a hollow cylindrical net structure by metal wires with a first diameter; and

a second interlacing layer, formed as another hollow cylindrical net structure by another metal wires with a second diameter, the first diameter being larger than the second diameter, the second interlacing layer covering the first interlacing layer in a sleeving manner.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of an embodiment of the composite fiber capillary structure in accordance with the present disclosure;

FIG. 2 is an enlarged view of area A of FIG. 1;

FIG. 3 is a cross sectional view along line B-B of FIG. 1;

FIG. 4 is a flowchart of a fabricating method of the composite fiber capillary structure in accordance with the present disclosure;

FIG. 5 is a schematic view of the heat pipe in accordance with the present disclosure;

FIG. 6 is a cross sectional view along line C-C of FIG. 5; and

FIG. 7 shows relationships of the thermal resistance and the operational power (heat transfer capacity) for both the conventional capillary-structured heat pipe and the heat pipe of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

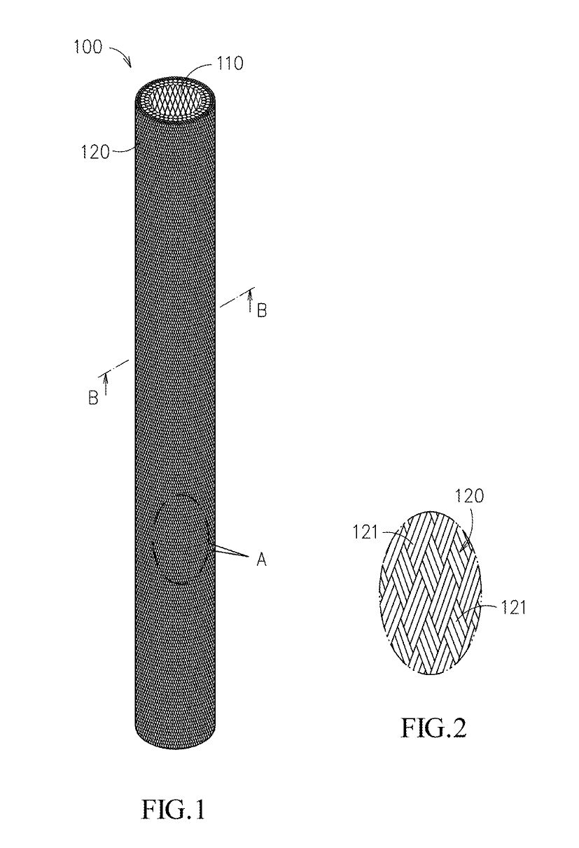

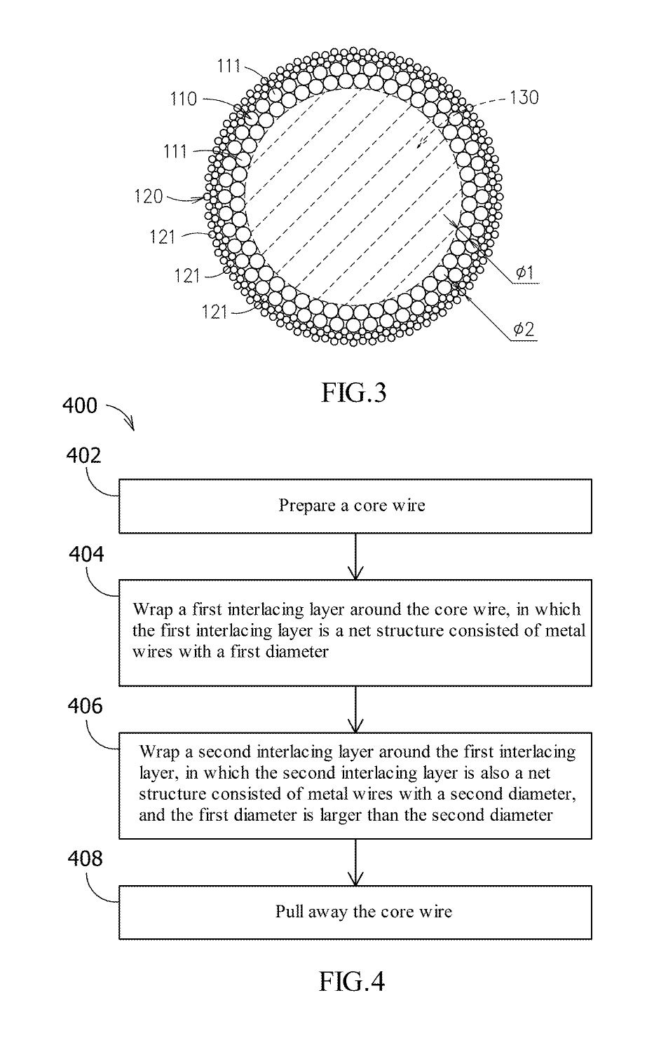

Referring now to FIG. 1, FIG. 2 and FIG. 3, a composite fiber capillary structure 100 of this disclosure includes a first interlacing layer 110 and a second interlacing layer 120. The first interlacing layer 110 is formed as a longitudinal hollow cylindrical net structure by interlacing at least a strand of metal wires 111 having a first diameter φ1. On the other hand, the second interlacing layer 120 is formed as a longitudinal hollow cylindrical net structure by interlacing at least a strand of metal wires 121 having a second diameter φ2. In particular, the first diameter φ1 is larger than the second diameter φ2. As shown, the second interlacing layer 120 covers the first interlacing layer 110 in a sleeving manner. The metal wires 111, 121 are both made of a metallic material with comprehensive thermal conductivity.

As shown in FIG. 2, the second interlacing layer 120 is, but not limited to be, formed by interlacing bundles of the metal wires 121, preferably four strands of metal wires 121 in a bundle. In practice, the number of strands of the metal wires 121 in a bundle is per requirement to the specific needs. Also, the formation of the first interlacing layer 110 of the metal wires 111 is similar to that of the second interlacing layer 120.

Referring now to FIG. 3 and FIG. 4, the fabricating method 400 of the composite fiber capillary structure 100 comprises the following steps.

Step 402: Prepare a core wire 130, in which the core wire 130 is not limited to be made of any specific material, but requires to have a specific hardness for sustaining the wrapping process for forming the first interlacing layer 110 and the second interlacing layer 120.

Step 404: Wrap a first interlacing layer 110 around the core wire 130, in which the first interlacing layer 110 is a net structure consisted of metal wires 111 with a first diameter φ1.

Step 406: Wrap a second interlacing layer 120 around the first interlacing layer 110, in which the second interlacing layer 120 is another net structure consisted of metal wires 121 with a second diameter φ2. In this disclosure, the first diameter φ1 is larger than the second diameter φ2.

Step 408: Pull away the core wire 130 from the formation of the first and second interlacing layers 110, 120.

In this disclosure, a determination of the second diameter and a thickness of the second interlacing layer is prior to that of the first diameter, a thickness of the first interlacing layer and a diameter of the core wire.

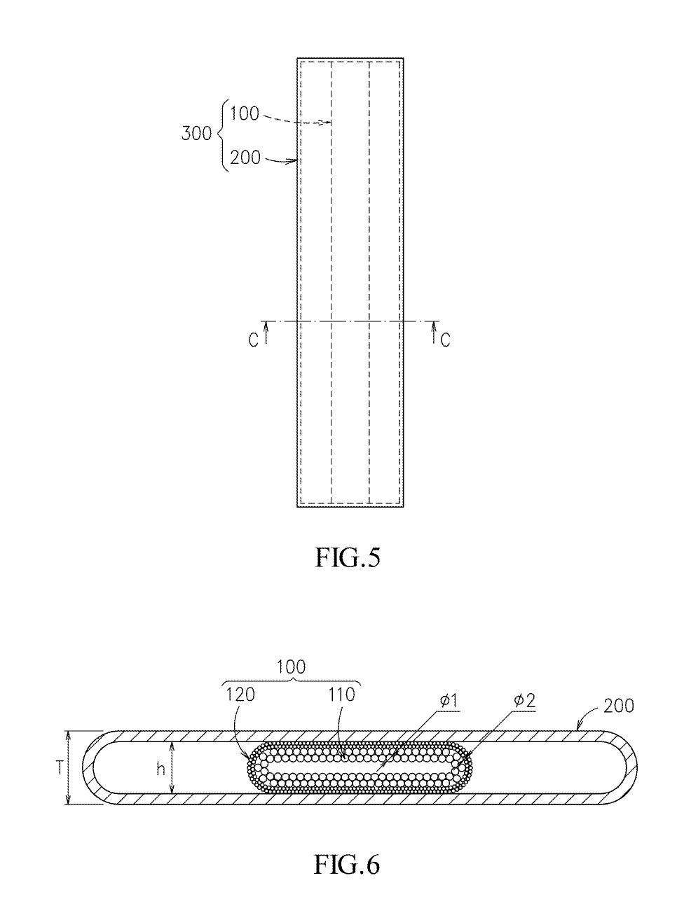

Referring now to FIG. 5 and FIG. 6, a thin heat pipe 300 of this disclosure is consisted of the composite fiber capillary structure 100 and an outer chamber structure 200. The composite fiber capillary structure 100 is formed as an inner chamber structure formed by an inner first interlacing layer 110 and an outer second interlacing layer 120. Both the outer chamber structure 200 and the metal wires for forming the inner chamber structure 100 (i.e. the same composite fiber capillary structure) including the first interlacing layer 110 and the second interlacing layer can be made of a metallic material with predetermined thermal conductivity, such as the copper, the aluminum, the stainless steel and so on. The formulation of the heat pipe 300 is to insert the inner chamber structure 100 in a shape of a longitudinal hollow cylinder as shown in FIG. 1 into the outer chamber structure 200 in the same shape. Then, the combination of the inner and outer chamber structures 100, 200 is depressed to become a flat structure shown in FIG. 6. One end of the combination is sealed, a vacuuming process is applied to vacuum the combination, a work fluid (water for example) is injected into the chamber structure 200, and finally another end of the combination is sealed as well. Upon such an arrangement, the composite fiber capillary structure 100 (i.e. the inner chamber structure) can be sealed inside the outer chamber structure 200 to have an appearance shown as FIG. 5 does.

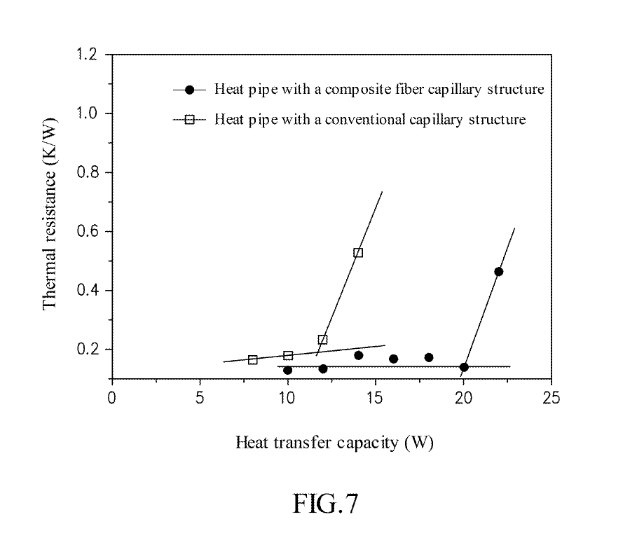

Referring to FIG. 6 and FIG. 7, it is proved that the embodiment in accordance with this disclosure does have improved performance. As shown in FIG. 6, when the heat pipe 300 has a 1.0-mm thickness T, the outer chamber structure 200 has an interior height h=0.7 mm, the metal wire for the first interlacing layer 110 has the first diameter φ1=0.1 mm, the metal wire for the second interlacing layer 120 has the second diameter φ2=0.05 mm, and the work fluid inside the outer chamber structure 200 is about a 116-mg water. Then, the operational power (the heat transfer capacity) W is plotted in FIG. 7 with respect to various thermal resistances. It is shown that the heat transfer capacity by the heat pipe with the composite fiber capillary structure of this disclosure is much superior to that by the conventional capillary-structured heat pipe. In addition, for the same operational power, the thin heat pipe with the composite fiber capillary structure of this disclosure is demonstrated to have a lower thermal resistance. For example in FIG. 7, to the operational power equal to 10 W, the thermal resistance for the heat pipe with the conventional capillary structure is about 0.2 K/W, while the thermal resistance for the heat pipe with the composite fiber capillary structure of this disclosure is reduced to about 0.1 K/W.

In summary, the composite fiber capillary structure provided by the present disclosure is a double-layer braided structure made up of metal wires. Since the sire size of the metal wire for the inner first interlacing layer is larger than that of the metal wire for the outer second interlacing layer, thus, while the composite fiber capillary structure provided by the present disclosure is applied to construct the heat pipe (especially the thin heat pipe), a larger work space can be provided for the interior wok fluid. Upon such an arrangement, the flow resistance can be reduced, the capillary forcing can be enhanced by the much denser second interlacing layer, and also the heat transfer capacity can be substantially increased.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A composite fiber capillary structure, comprising:
a first interlacing layer, formed as a hollow cylindrical net structure by metal wires with a first diameter; and
a second interlacing layer, formed as another hollow cylindrical net structure by another metal wires with a second diameter, the first diameter being larger than the second diameter, the second interlacing layer covering the first interlacing layer in a sleeving manner.

2. The composite fiber capillary structure of claim 1, wherein the first interlacing layer is the net structure formed by interlacing at least one strand of the metal wires with the first diameter, and the second interlacing layer is the another net structure formed by interlacing at least one strand of the another metal wires with the second diameter.

3. The composite fiber capillary structure of claim 1, wherein the metal wires and the another metal wires are both made of metallic materials with predetermined thermal conductivity.

4. A fabricating method of a composite fiber capillary structure, comprising the steps of:
preparing a core wire;
wrapping the core wire by a first interlacing layer, the first interlacing layer being formed as a net structure of metal wires with a first diameter;
wrapping the first interlacing layer by a second interlacing layer, the second interlacing layer being formed as another net structure of metal wires with a second diameter, the first diameter being larger than the second diameter; and
pulling away the core wire.

5. The fabricating method of a composite fiber capillary structure of claim 4, wherein a determination of the second diameter and a thickness of the second interlacing layer is prior to that of the first diameter, a thickness of the first interlacing layer and a diameter of the core wire.

6. The fabricating method of a composite fiber capillary structure of claim 4, wherein the net structure of the first interlacing layer is formed by interlacing at least one strand of the metal wires with the first diameter, and the another net structure of the second interlacing layer is formed by interlacing at least one strand of the another metal wires with the second diameter.

7. The fabricating method of a composite fiber capillary structure of claim 4, wherein the metal wires and the another metal wires are both made of metallic materials with predetermined thermal conductivity.

8. A heat pipe, comprising:
an outer chamber structure, vacuum sealed, containing thereinside a work fluid; and
a composite fiber capillary structure, located inside the outer chamber structure, further comprising:
a first interlacing layer, formed as a hollow cylindrical net structure by metal wires with a first diameter; and
a second interlacing layer, formed as another hollow cylindrical net structure by another metal wires with a second diameter, the first diameter being larger than the second diameter, the second interlacing layer covering the first interlacing layer in a sleeving manner.

9. The heat pipe of claim 8, wherein the net structure of the first interlacing layer is formed by interlacing at least one strand of the metal wires with the first diameter, and the another net structure of the second interlacing layer is formed by interlacing at least one strand of the another metal wires with the second diameter.

10. The heat pipe of claim 8, wherein the metal wires and the another metal wires are both made of metallic materials with predetermined thermal conductivity.
